(19) United States
(12) Patent Application Publication
(10) Pub. No.: US 2013/0265063 A1
(43) Pub. Date: Oct. 10, 2013

(54) METHOD AND APPARATUS FOR DETECTING THE PRESENCE OF WATER IN A CURRENT OF LIQUID HYDROCARBONS

(71) Applicants: Daniel Patrick Cherney, Hampton, NJ (US); Alan Mark Schilowitz, Highland Park, NJ (US)

(72) Inventors: Daniel Patrick Cherney, Hampton, NJ (US); Alan Mark Schilowitz, Highland Park, NJ (US)

(73) Assignee: EXXONMOBIL RESEARCH AND ENGINEERING COMPANY, Annandale, NJ (US)

(21) Appl. No.: 13/793,247

(22) Filed: Mar. 11, 2013

Related U.S. Application Data
(60) Provisional application No. 61/621,157, filed on Apr. 6, 2012.

(51) Int. Cl. G01N 27/06

(52) U.S. Cl. CPC G01N 27/06
USPC 324/695

(57) ABSTRACT

Provided is an apparatus for detecting the presence of water in a current of liquid hydrocarbons. The apparatus comprises at least one pair of electrodes for detecting the presence of water in a sample zone in the current of liquid hydrocarbons located therebetween; alternating current generating circuitry for generating an alternating current between the electrodes; measuring circuitry for measuring the electrical impedance of the current of liquid hydrocarbons between the electrodes; and a processor for collecting data from the measuring circuitry, processing the data and outputting the data for use in detecting the presence of water in the current of liquid hydrocarbons. A method is provided for detecting the presence of water in a current of liquid hydrocarbons and for quantifying the amount of free water present in a current of liquid hydrocarbons. An apparatus is provided for quantifying the amount of free water present in a current of liquid hydrocarbons.

### CROSS-REFERENCE TO RELATED APPLICATIONS

This application claims the benefit of U.S. Provisional Application Ser. No. 61/621,157, filed on Apr. 6, 2012; which is incorporated herein in its entirety by reference.

### FIELD

This disclosure relates to an apparatus for detecting the presence of water in a current of liquid hydrocarbons, a method for detecting the presence of water in a current of liquid hydrocarbons, a method for quantifying the amount of free water present in a current of liquid hydrocarbons, and an apparatus for quantifying the amount of free water present in a current of liquid hydrocarbons.

### BACKGROUND

In many industrial processes involving fluids that flow continuously, e.g., hydrocarbon streams, there is a need for accurate and inexpensive monitoring methods, for example, the detection of the presence of water in hydrocarbon streams. It is desirable that these methods have the capability of working on-line with the processes.

The presence of water in an oil production pipeline is indicative of a location(s) where the potential for corrosion is significantly greater than locations along the pipeline where oil wets the interior pipe wall. Water-wetting of a pipe greatly accelerates corrosion over an oil-wet pipe via a number of different means. Microbial induced corrosion (MIC) in a pipeline is most likely to occur in the presence of a water-wetted pipe.

Typical pipeline pigs are used to inspect crude oil pipelines. Pigs are relatively large devices which can be used only in relatively large diameter pipe. A smaller device would enable inspection in small diameter pipe. In addition, a small inspection device, which did not occupy the entire inner diameter space of the pipe, could be used during crude oil production. Larger pigging devices require significant disruption of crude oil flow in the pipeline.

There are methods disclosed in the art for detecting water inside of hydrocarbon pipelines. A number of patents have been issued relating conductivity to water content in a hydrocarbon pipeline. For example, U.S. Pat. No. 5,033,289 describes a method to measure the amount of water in a liquid volume by measuring the impedance between 10 MHz and 200 MHz, and comparing the signal to a reference. The stationary probe is calibrated so that the change in impedance can be correlated to the amount of water in the pipeline. U.S. Pat. No. 5,095,758 describes a stationary device that monitors the total impedance of a fluid in a separated tank. All measured impedances are related to the impedance of water and this determines the water cut in the tank. U.S. Pat. No. 4,240,028 describes a sensor that measures water in a pipe or core sample. The amplitude and frequency of the signal is translated into the amount of water in oil. U.S. Pat. No. 4,751,842 describes the use of a capacitance sensor mounted onto a non-conductive pipe. The measured capacitance in the pipe changes based on the dielectric constant of the flowing liquid.

There is no apparatus in the art, of which we are aware, that can detect free water inside of a hydrocarbon pipeline and move through the pipeline. Rather than detecting water at a single point along the pipeline, it is desirable to detect free water along an entire segment of pipe. As indicated above, the presence of free water is a leading indicator of corrosion, and several types of corrosion occur in locations where water wets the pipe wall. Intelligent pigging of pipelines is performed on an infrequent basis (e.g., every 3-5 years) and can give information relating to wall loss. However, it may be too late to prevent wall loss by the time this information is obtained. In addition, not all pipelines are amenable to intelligent pigging.

Therefore, a need exists for developing an apparatus that can detect free water inside of a hydrocarbon pipeline and move through the pipeline. The apparatus desirably should allow the detection of free water along an entire segment of pipe and not just the detection of water at a single point along the pipeline. The apparatus should be relatively immune from fouling. Crude oil can be a relatively dark and viscous fluid which is highly fouling to a sensor apparatus.

The present disclosure also provides many additional advantages, which shall become apparent as described below.

### SUMMARY

This disclosure relates in part to an apparatus for detecting the presence of water in a current of liquid hydrocarbons, the apparatus comprising:

at least one pair of electrodes for detecting the presence of water in a sample zone in the current of liquid hydrocarbons located therebetween;

alternating current (AC) generating circuitry for generating an alternating current between the electrodes;

measuring circuitry for measuring the electrical impedance of the current of liquid hydrocarbons between the electrodes; and

a processor for collecting data from the measuring circuitry, processing the data and outputting the data for use in detecting the presence of water in the current of liquid hydrocarbons.

This disclosure also relates in part to a method for detecting the presence of water in a current of liquid hydrocarbons comprising:

providing an apparatus comprising:

at least one pair of electrodes for detecting the presence of water in a sample zone in the current of liquid hydrocarbons located therebetween;

alternating current (AC) generating circuitry for generating an alternating current between the electrodes;

measuring circuitry for measuring the electrical impedance of the current of liquid hydrocarbons between the electrodes; and

a processor for collecting data from the measuring circuitry, processing the data, and outputting the data; and
using the outputted data from said apparatus for detecting the presence of water in the current of liquid hydrocarbons.

This disclosure further relates in part to a method for detecting the presence of water in a current of liquid hydrocarbons comprising:

applying alternating current (AC) to a portion of the current of liquid. hydrocarbons; and

measuring the electrical impedance spectrum across the portion of the current of liquid hydrocarbons;
whereby the presence of water can be determined from the measured electrical impedance spectrum.

The disclosure yet further relates in part to a method for quantifying the amount of water present in a current of liquid hydrocarbons comprising:

applying alternating current (AC) to a portion of the current of liquid hydrocarbons; and

measuring the electrical impedance spectrum across the portion of the current of liquid hydrocarbons;
whereby the amount of water can be determined from the measured electrical impedance spectrum.

The disclosure also relates in part to an apparatus for quantifying the amount of free water present in a current of liquid hydrocarbons, the apparatus comprising:

at least two pairs of electrodes for detecting the presence of water in sample zones in the current of liquid hydrocarbons located therebetween;

alternating current (AC) generating circuitry for generating an alternating current between each pair of electrodes;

measuring circuitry for measuring the electrical impedance of the current of liquid hydrocarbons between each pair of electrodes; and
a processor for collecting data from the measuring circuitry, determining which of the electrodes is in contact with water, processing the data and outputting the data for use in determining the height of the water level in the current of liquid hydrocarbons.

The disclosure further relates in part to a method for quantifying the amount of free water present in a current of liquid hydrocarbons comprising:

providing an apparatus comprising:

at least two pairs of electrodes for detecting the presence of water in sample zones in the current of liquid hydrocarbons located therebetween;

alternating current (AC) generating circuitry for generating an alternating current between each pair of electrodes;

measuring circuitry for measuring the electrical impedance of the current of liquid hydrocarbons between each pair of electrodes; and

a processor for collecting data from the measuring circuitry, determining which of the electrodes is in contact with water, processing the data and outputting the data for use in determining the height of the water level in the current of liquid hydrocarbons; and
using the outputted data from said apparatus for quantifying the amount of free water present in a current of liquid hydrocarbons.

An advantage of the present disclosure is that the apparatus is relatively immune from fouling. Crude oil can be a relatively dark and viscous fluid which is highly fouling to a sensor apparatus. While the apparatus of this disclosure is readily coated with crude oil, the apparatus has been demonstrated to work in the presence of such fouling and able to detect water even in the presence of an oily surface coating.

Another advantage of the present disclosure is that the apparatus can be applied by mounting at a fixed point in a pipeline to detect water as the fluid flows by. Alternatively, the apparatus may be mounted to a movable device which moves through the pipeline and detects water where it may be in the pipeline.

Further objects, features and advantages of the present disclosure will be understood by reference to the following drawings and detailed description.

### BRIEF DESCRIPTION OF THE DRAWINGS

FIG. 1 graphically depicts the magnitude of the impedance vector plotted versus AC frequency. The approximate amount of the probe immersed in the brine, determined by visual inspection, is displayed in the legend. The remainder of the probe was immersed in condensate. The brine was approximately 3 wt. % sodium chloride in distilled water (hereinafter called “brine”). FIG. 1 is discussed in Example 1 below.

FIG. 2 graphically depicts the magnitude of the impedance vector plotted versus AC frequency. The total amount of brine is indicated in the legend, Also indicated is the total amount of condensate that was removed from the volume. All measurements were taken while the volume was stirring unless otherwise indicated. FIG. 2 is discussed in Example 2 below.

FIG. 3 graphically depicts the magnitude of the impedance vector plotted versus AC frequency. The impedance of the crude-covered probe (hereinafter called “fouled”) placed in both stagnant and stirred brine solutions is significantly different than that of hydrocarbon. In this case, the impedance spectra of the Marimba crude are the first three data sets in the legend. FIG. 3 is discussed in Example 3 below.

FIG. 4 is a schematic showing a sphere with multiple electrodes where some of the electrodes are in water and some in oil. FIG. 4 is discussed in Example 4 below.

FIG. 5 graphically depicts impedance measurement at 25% water level. FIG. 5 is discussed in Example 4 below.

FIG. 6 is a photograph of the sensor test piece exposed to liquid in a flowing stream (25% water and 75% isopar fluid) used in Example 4 below.

FIG. 7 is a schematic showing electrodes in water and oil (isopar) where all but one pair of electrodes is immersed in water and one pair is immersed in oil. FIG. 7 is discussed in Example 4 below.

FIG. 8 graphically depicts impedance measurement at 75% water level. FIG. 8 is discussed in Example 4 below.

FIG. 9 graphically depicts slug flow data (impedance versus time). FIG. 9 is discussed in Example 4 below.

FIG. 10 is a schematic of a slug flow simulation. FIG. 10 is discussed in Example 4 below.

FIG. 11 graphically depicts crude oil emulsion data (impedance versus frequency (Hz). FIG. 11 is discussed in Examples 4 and 5 below.

FIG. 12 graphically depicts emulsion data (Marimba emulsion) for use in calculating water concentration (impedance versus frequency (Hz). FIG. 12 is discussed in Examples 4 and 5 below.

FIG. 13 graphically depicts emulsion data (Marimba emulsion) to calculate water concentration (impedance versus % brine). FIG. 13 is discussed in Examples 4 and 5 below.

FIG. 14 graphically depicts the impedance spectra of air and brine with an interdigitated microelectrode (IME). FIG. 14 is discussed in Example 6 below.

FIG. 15 graphically depicts the impedance recorded at 1 kHz of an interdigitated microelectrode pair that has been fouled with crude oil and is immersed in brine. FIG. 15 is discussed in Example 6 below.

FIG. 16 is a schematic representation of a general set-up (i.e., computer, potentiostat, wires, polycarbonate spacer, electrodes and copper rods) for a single electrode pair.

FIG. 17 is a schematic representation of exemplary electrode configurations (i.e., polycarbonate spacer, electrodes and copper rods in one representation and interior electrode, outer electrode, gap and electrical insulator in the other representation) for a single electrode pair.

FIG. 18 is a schematic representation of an exemplary sensor package (i.e., computer, potentiostat, box to pick circuit for measurement, wires, electrodes, tubes for wires, pin to eliminate possibility of spinning and pipe wall).

FIG. 19 is a cross-sectional view of a mobile sensor device with a single pair of electrodes. The cross-sectional view shows AC generating circuitry, processor, measuring circuitry, wires, electrodes, and the deployment mechanism which is a sphere as depicted.

FIG. 20 displays the electric field strength in two dimensions in a common color scale with the intensity of the color scale matched in each image.

FIG. 21 is a plot of impedance and frequency of a condensate-brine volume.

### DETAILED DESCRIPTION

All numerical values within the detailed description and the claims herein are modified by “about” or “approximately” the indicated value, and take into account experimental error and variations that would be expected by a person having ordinary skill in the art.

For purposes of this disclosure, impedance spectra can be measured while maintaining a constant voltage signal (i.e., an oscillating signal which remains the same) or by maintaining a constant alternating current. For the measurements made herein, a potentiostat was used where a constant voltage signal was maintained and the current measured. This disclosure is not intended to be limited in any way by methodologies for measurement of impedance spectra.

The present disclosure monitors the magnitude of the AC impedance between two electrodes. The magnitude of the total impedance can be used to determine whether there is water in a pipeline and amount of water, e.g., its level if it is free water and its concentration if it is emulsified water. Water is defined to include free water, a hydrocarbon-in-water emulsion, or a water-in-hydrocarbon emulsion. The device can be used at multiple frequencies or can be used at a single frequency to monitor the fluid between the electrodes.

As used herein, the term “electrical contact” means that the electrodes are close enough that there is a measureable impedance between them.

As indicated above, this disclosure also relates in part to a method for detecting the presence of water, e.g., its level if it is free water and its concentration if it is emulsified water, in a current of liquid hydrocarbons. The method comprises providing an apparatus and using the outputted data from the apparatus for detecting the presence of water in the current of liquid hydrocarbons. The apparatus comprises at least one pair of electrodes for detecting the presence of water in a sample zone in the current of liquid hydrocarbons located therebetween; alternating current (AC) generating circuitry for generating an alternating current between the electrodes; measuring circuitry for measuring the electrical impedance of the current of liquid hydrocarbons between the electrodes; and a processor for collecting data from the measuring circuitry, processing the data, and outputting the data.

This disclosure relates to a method for detecting the presence of water, e.g., its level if it is free water and its concentration if it is emulsified water, in a current of liquid hydrocarbons. The method comprises applying alternating current (AC) to a portion of the current of liquid hydrocarbons; and measuring the electrical impedance spectrum across the portion of the current of liquid hydrocarbons; whereby the presence of water can be determined from the measured electrical impedance spectrum.

This disclosure also relates to methods for quantifying the amount of water when the water phase is continuous with oil domains dispersed into the continuous oil phase as well as quantifying the amount of water when the oil phase is continuous and water domains are dispersed into the continuous oil phase. It also relates to differentiating between water continuous oil in water emulsions and oil continuous water in oil emulsions.

This disclosure also relates to a method for quantifying the amount of free water present in a current of liquid hydrocarbons. The method comprises applying alternating current (AC) to a portion of the current of liquid hydrocarbons; and measuring the electrical impedance spectrum across the portion of the current of liquid hydrocarbons; whereby the amount of water can be determined from the measured electrical impedance spectrum.

As used herein, “impedance spectrum” refers to the complex plane plot of impedance values for a plurality of different frequencies of alternating current or voltage in the plotting of quantities derived from the impedance values. Impedance spectrum can also refer to other ways of plotting impedance data such as total impedance magnitude versus frequency, real impedance versus frequency, imaginary impedance versus frequency, and any other meaningful representations of the impedance spectrum.

The method can be repeated for a plurality of different amplitudes of alternating voltage. The alternating input includes alternating voltage and alternating current. The AC sinusoidal signal can oscillate around the average value of zero. Alternatively, a DC offset level can be imposed on the AC signal where the AC signal oscillates around an average point other than zero.

The alternating voltage is applied across electrodes in the portion of the current of liquid hydrocarbons. The term “electrodes” should be interpreted in its broadest sense to include any terminal, wires, or similar points across which current or voltage can be applied to measure the alternating current impedance spectrum. The electrodes are set a predetermined distance apart and alternating current impedance measurements are made at the predetermined distance of separation between electrodes.

As indicated above, this disclosure also relates to an apparatus for detecting the presence of water, e.g., its level if it is free water and its concentration if it is emulsified water, in a current of liquid hydrocarbons. The apparatus comprises at least one pair of electrodes for detecting the presence of water in a sample zone in the current of liquid hydrocarbons located therebetween; alternating current (AC) generating circuitry for generating an alternating current between the electrodes; measuring circuitry for measuring the electrical impedance of the current of liquid hydrocarbons between the electrodes; and a processor for collecting data from the measuring circuitry, processing the data and outputting the data for use in detecting the presence of water in the current of liquid hydrocarbons.

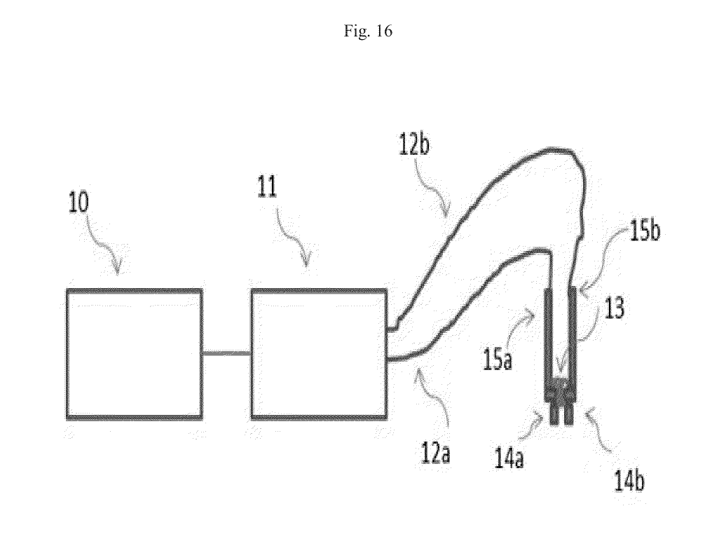

As shown in FIG. 16, an exemplary general set-up of the apparatus of this disclosure includes measuring circuitry, i.e., a potentiostat 11, for measuring the magnitude of total electrical impedance of a current of liquid hydrocarbons between the electrodes 14a and 14b and making measurements of impedance spectra, and a computer 10 for collecting data from the potentiostat 11, processing the data and outputting the data. The alternating current generating circuitry for generating an alternating current and making an impedance measurement between the electrodes 14a and 14b includes wires 12a and 12b, polycarbonate spacer 13, and copper rods 15a and 15b.

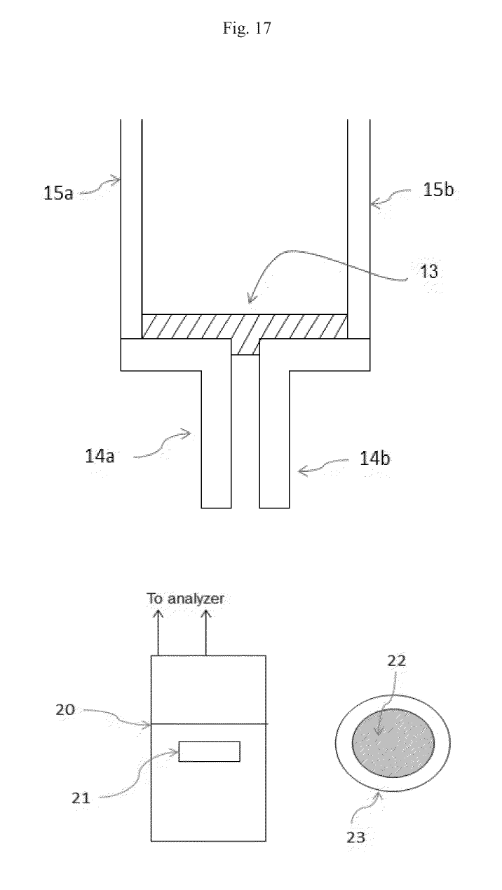

FIG. 17 shows an exemplary planar electrode pair configuration that includes the polycarbonate spacer 13, electrodes 14a and 14b, and copper rods 15a and 15b in one representation. In the other representation of a cylindrical electrode pair, the interior electrode 22, the outer electrode 23, a window for fluid displacement 21, and electrical insulator 20 are shown.

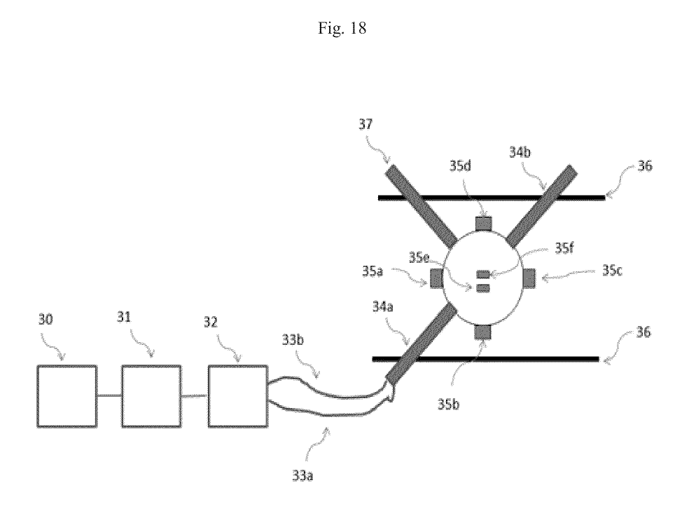

As shown in FIG. 18, an exemplary sensor package of this disclosure includes measuring circuitry, i.e., a potentiostat 31, for measuring the magnitude of total electrical impedance of a current of liquid hydrocarbons between the electrodes 35a, 35b, 35c, 35d, 35e and 35f and measuring impedance spectra, and a computer 30 for collecting data from the potentiostat 31, processing the data and outputting the data. The alternating current generating circuitry for generating an alternating current and making an impedance measurement between the electrodes 35a, 35b, 35e, 35d, 35e and 35f includes a box 32 to pick an electrode pair for measurement, wires 33a and 33b, tubes 34a and 34b for the wires, a pin 37 to eliminate the possibility of spinning if the sensor package is fixedly mounted inside a pipe or vessel, and pipe wall 36. The sensor package may also freely move inside a pipe and detect the presence of water at different locations inside the pipe.

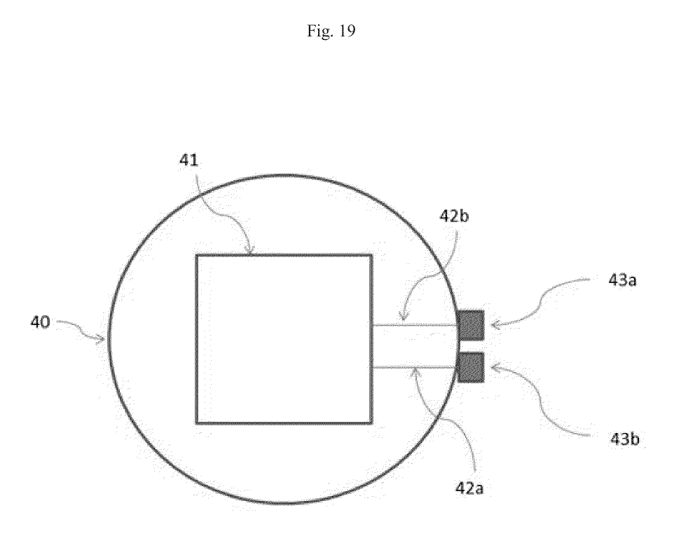

FIG. 19 shows a cross-sectional view of a mobile sensor device of this disclosure with a single pair of electrodes. The cross-sectional view shows the alternating current generating circuitry, measuring circuitry, and processor in box 41, wires 42a and 42b, and electrodes 43a and 43b. The deployment mechanism 40 is depicted as a sphere.

The apparatus preferably includes two electrodes. Preferably the electrical impedance spectrum is measured across the electrodes for a constant amplitude of potential difference (voltage).

This disclosure also relates to a method fir detecting the amount of free water in a flowing oil pipeline. In an especially preferred embodiment, a plurality of pairs of electrodes are mounted on a three dimensional body which can move through the pipeline in the presence of crude oil. The three-dimensional body is preferably round but it can be any shape that is able to move through the pipeline. The body may be self-propelled or it may be designed to move in the flowing fluid. The plurality of electrode pairs is mounted so that they sample the crude oil at different points or levels, Each electrode pair is preferably interrogated independently so that the presence of water can be detected discretely. In this way, it can be determined if water is present between any electrode pairs. If water is present, it can also be determined which electrode pairs are detecting water. This enables determination of the height of water in the flowing oil.

The three-dimensional body may also be fitted with a self-contained, locally powered computer which can acquire data while it flows through the flowing oil pipeline storing water data (e.g., concentration or presence of water) as it moves along. It can also contain a device capable of determining its position such as an inertial measuring unit (MU) or a device capable of counting pipe welds and the like for determining position inside a metallic pipe. If such a positioning device is present, then water information can be integrated with position to produce a map of water concentration or water presence versus position within the pipeline. In an embodiment, the three-dimensional body is fitted with a computer and a positioning device capable of determining position of said apparatus inside a pipeline.

The plurality of electrode pairs can also be mounted in fixed locations around the diameter of a pipe. The plurality of electrode pairs can be mounted so that they sample the crude oil at different points or levels. Each electrode pair is preferably interrogated independently so that the presence of water can be detected discretely. In this way, it can be determined if water is present between any electrode pairs. If water is present, it can also be determined which electrode pairs are detecting water. This enables determination of the height of water in the flowing oil.

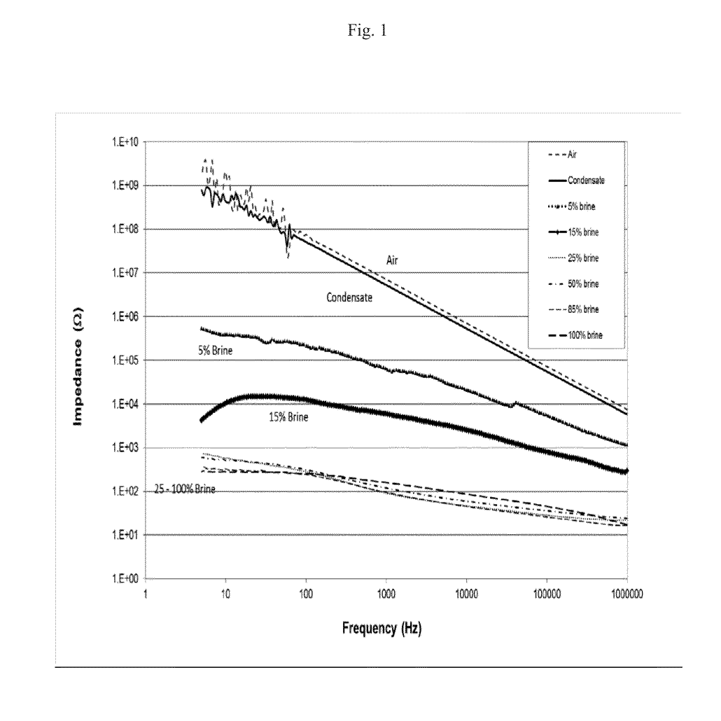

As demonstrated in FIG. 1, it is possible to get an accurate determination of water level by interpreting the impedance signal from an individual electrode pair. FIG. 1 shows that, as water intrudes between an electrode pair, a quantitative reduction in impedance is observed indicating the quantity of water present between the electrode pair. If the electrode pair was mounted vertically, this would be an indication of the free water height.

The apparatus may also include more than one pair of electrodes, e.g., two electrode pairs. Preferably, the two pairs of electrodes are each adapted to measure impedance under constant alternating voltage or constant alternating current conditions.

It is preferred that the apparatus includes a configuration of electrodes in which either a sinusoidal current of constant root mean square (RMS) amplitude is applied across the electrodes or a sinusoidal voltage of constant RMS amplitude is applied across the electrodes.

Preferably, the AC signal will be a relatively pure sinusoidal sine wave type signal. However, it is recognized that other alternating signals may also be effective such as saw tooth waves, square waves, and the like.

An important aspect of the present disclosure is the ability of the apparatus to function after being fouled by crude oil. Crude oil can be a viscous, sticky, dark fluid which can coat the electrodes with a water impervious oily surface. If water cannot enter the gap between the electrode pair or if the gap is such that the oil coating eliminates electrical contact between the two electrodes, then the sensor will be unable to detect the presence of water in the flowing crude pipeline. The electrode pairs in the apparatus are such that, despite crude fouling, the electrode pair can detect water.

The electrode pairs are made out of an electrical conducting material such as copper. Preferably, the electrode pair is made out of a corrosion resistant material such as stainless steel. The electrode pair may also be made or finished by depositing a thin layer of precious metal such as gold or platinum. The electrode pairs can be made out of two opposing surfaces such as concentric cylinders. More preferably they are two flat opposing surfaces.

The gap between the electrode pair must be sufficient to allow oil and water in between, but the gap must also be small enough to allow the plates to remain within electrical contact. The gap should be between 1 and 15 millimeters, preferably between 2 and 10 millimeters, and most preferably between 2 and 6 millimeters.

The area of overlap between each electrode pair should be between 0.1 and 100 square centimeters, preferably between 0.2 and 10 square centimeters, more preferably between 0.2 and 5 square centimeters, and most preferably between 0.2 and 4 square centimeters.

As indicated above, this disclosure relates to an apparatus for quantifying the amount of free water present in a current of liquid hydrocarbons. The apparatus comprises: at least two pairs of electrodes for detecting the presence of water in sample zones in the current of liquid hydrocarbons located therebetween; alternating current (AC) generating circuitry for generating an alternating current between each pair of electrodes; measuring circuitry for measuring the electrical impedance of the current of liquid hydrocarbons between each pair of electrodes; and a processor for collecting data from the measuring circuitry, determining which of the electrodes is in contact with water, processing the data and outputting the data for use in determining the height of the water level in the current of liquid hydrocarbons.

This disclosure relates to a method for quantifying the amount of free water present in a current of liquid hydrocarbons. The method comprises providing an apparatus and using the outputted data from the apparatus for quantifying the amount of free water present in a current of liquid hydrocarbons. The apparatus comprises: at least two pairs of electrodes for detecting the presence of water in sample zones in the current of liquid hydrocarbons located therebetween; alternating current (AC) generating circuitry for generating an alternating current between each pair of electrodes; measuring circuitry for measuring the electrical impedance of the current of liquid hydrocarbons between each pair of electrodes; and a processor for collecting data from the measuring circuitry, determining which of the electrodes is in contact with water, processing the data and outputting the data for use in determining the height of the water level in the current of liquid hydrocarbons.

Various modifications and variations of this disclosure will be obvious to a worker skilled in the art and it is to be understood that such modifications and variations are to be included within the purview of this application and the spirit and scope of the claims.

### EXAMPLES

### Example 1

FIG. 1 shows the magnitude of the impedance (the vector sum of the real and imaginary components of impedance) with the electrodes immersed at various levels in a stagnant brine-condensate liquid. The brine was approximately 3 wt. % sodium chloride in distilled water (“brine”). Brine is used in the examples herein because it is typical for water in hydrocarbon pipelines to contain salts. The terms brine and water are interchangeable for purposes of this disclosure. The condensate was a Ras Gas condensate. The density of condensate is lower than that of brine, so this layer rests on top of the brine. The sensor used to create this plot is a 1 cm×1 cm square pair of copper electrodes connected to a Solartron SI 1260 Impedance/Gain-Phase Analyzer. The electrode was initially lowered from air into the condensate layer. The electrode was then slowly lowered into the brine such that the lower portion of the electrodes was in the brine layer and the top portion of the electrodes was still in the condensate. The impedance in air is greatest at all frequencies. The impedance of the condensate is slightly lower. The impedance is reduced when the sensor is lowered such that the bottoms of the sensing electrodes make contact with the brine.

### Example 2

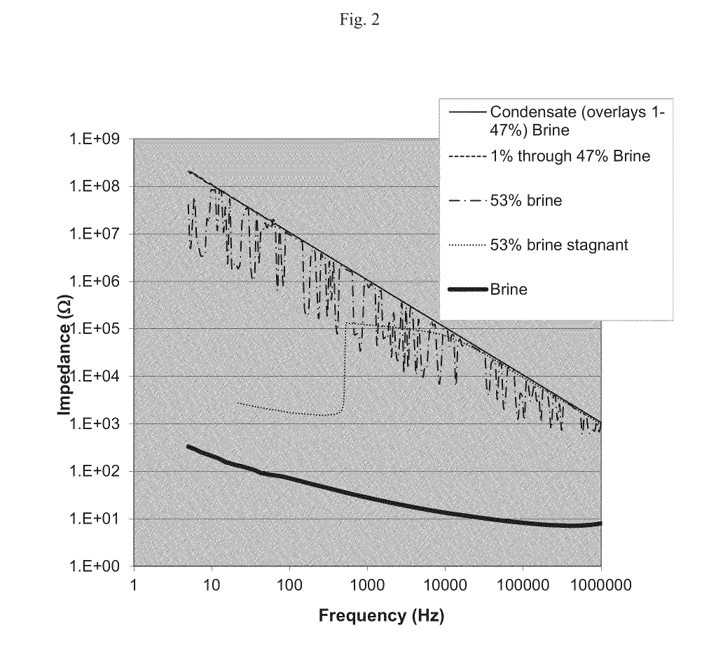

The sensor of this disclosure is also capable of detecting emulsified water. In this case the water is dispersed into a continuous oil phase. FIG. 2 shows a plot of impedance and frequency of a condensate-brine volume. The sensor used to obtain this data was a pair of concentric steel cylinders. The gap between the concentric cylinders was 2 millimeters. The combined surface area of the concentric cylinders was 10.4 square centimeters. The overlap area between the concentric cylinders was 3.8 square centimeters, The volume was changed by either adding brine or removing condensate while the stirring was stopped. At a particular condensate:brine volume ratio, the impedance deviates from the hydrocarbon, indicating the presence of water in a hydrocarbon:brine emulsion.

### Example 3

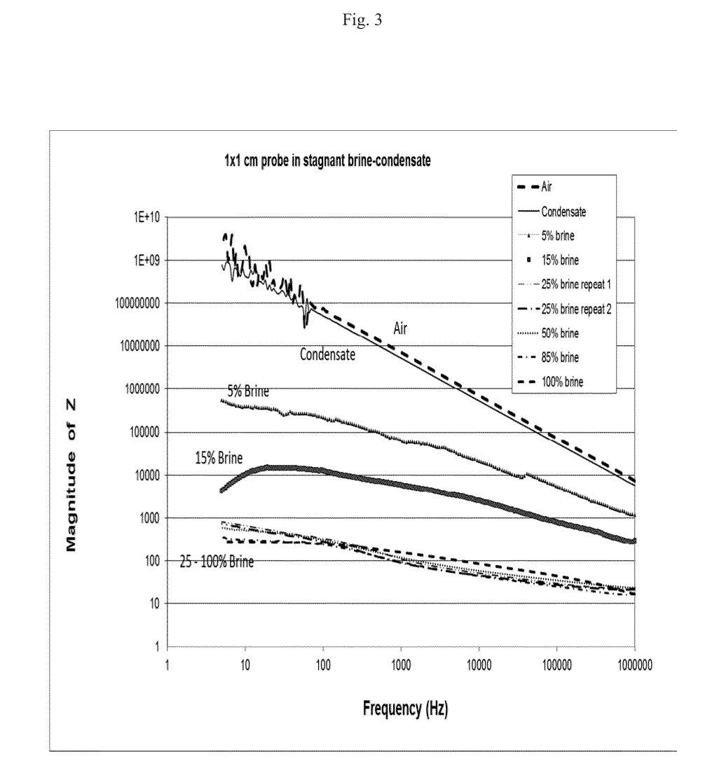

The sensor of this disclosure shows some immunity to fouling. FIG. 3 shows the impedance spectrum of the sensor that had been placed in Marimba crude at room temperature for approximately 70 hours. The electrodes are the concentric cylinders, same as those used in FIG. 2. The gap between the concentric cylinders was 2 millimeters. The combined surface area of the concentric cylinders was 10.4 square centimeters. The overlap area between the concentric cylinders was 3.8 square centimeters. The probe was removed from the crude and placed into a volume of stagnant brine without any cleaning It is clear that there is a significant difference in the impedance, even in stagnant brine, between the hydrocarbon volume and the brine volume.

### Example 4

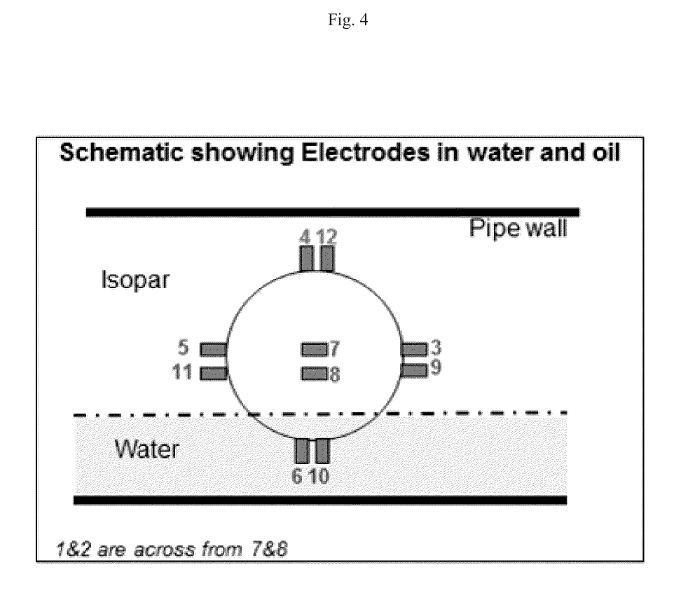

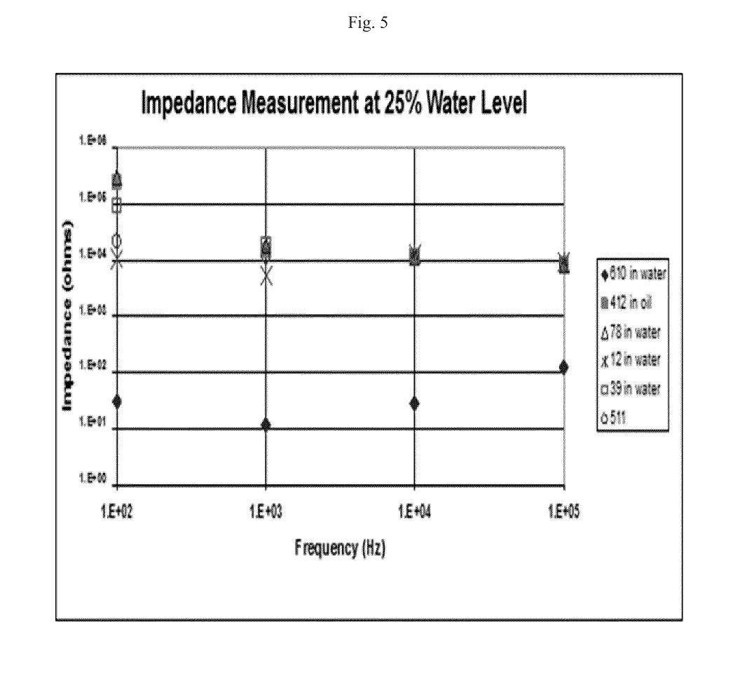

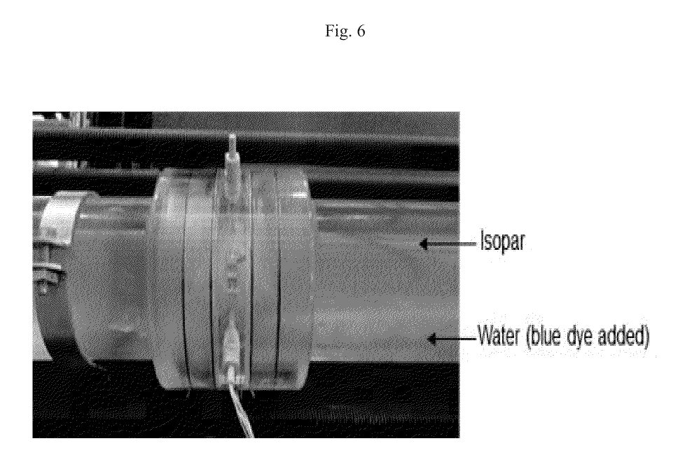

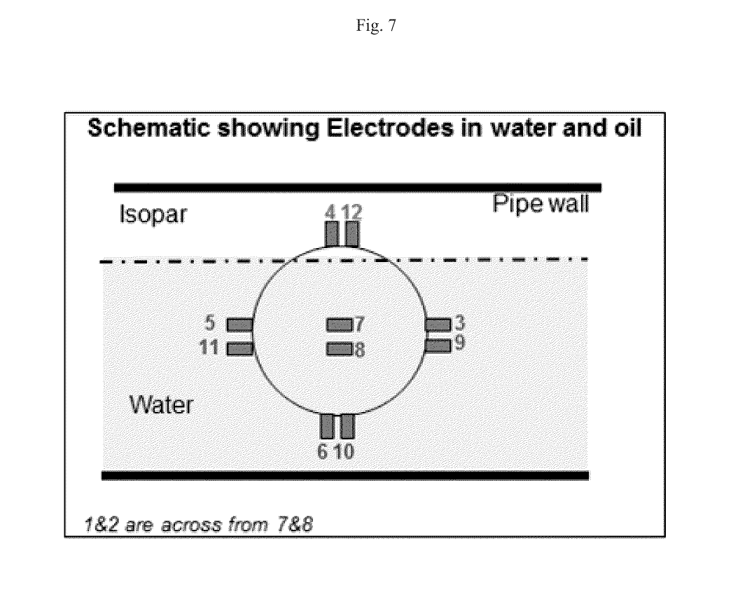

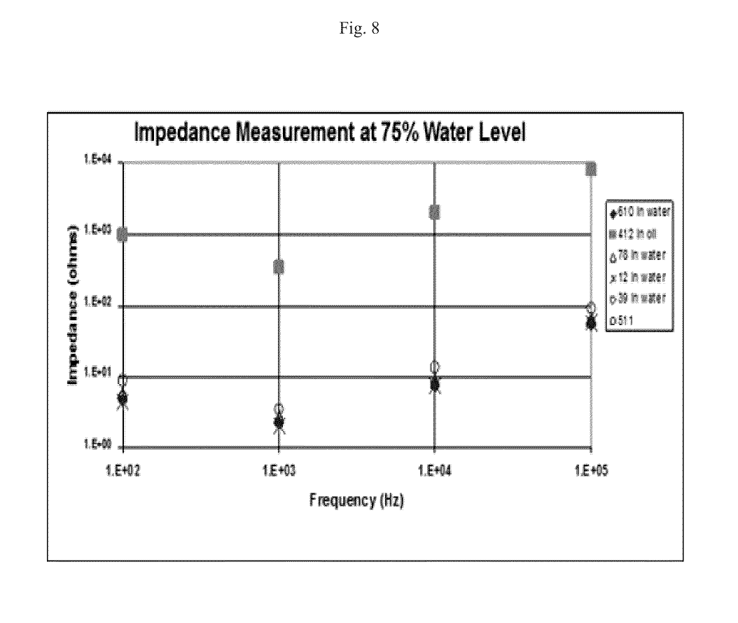

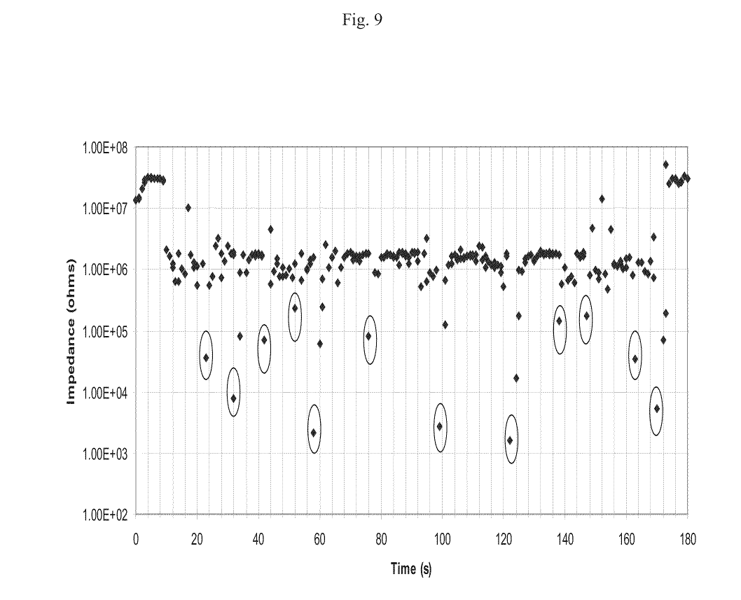

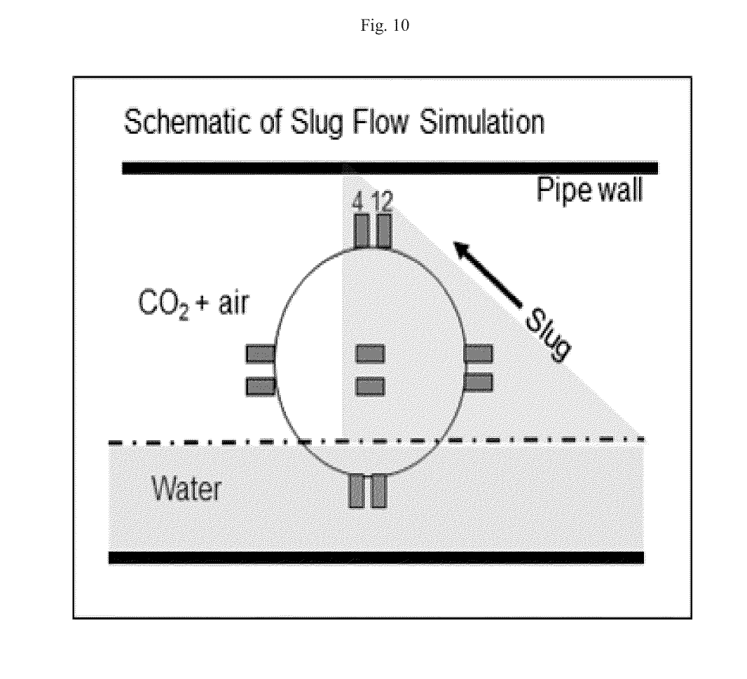

A sensor device was fixedly positioned in a section of a flow loop pipe. Liquids and gas were flowed through the flow loop and the impedance was measured using different pairs of electrodes. FIGS. 4, 5 and 6 relate to a flow of approximately 25% water and 75% oil. FIGS. 7 and 8 relate to a flow of 75% water and 25% oil. FIGS. 9 and 10 relate to slug flow. The slug flow data shows how fast the sensor can respond to water. Data was collected using an AC voltage of 100 millivolts with 0 volts DC offset and a frequency of 1 kHz from the top pair of electrodes (4, 12) shown in FIG. 10. Circled points in the data shown in FIG. 9 show the first point where a slug was detected. Points with lower impedance immediately after circled points indicate that there was likely some water between the electrodes.

### Example 5

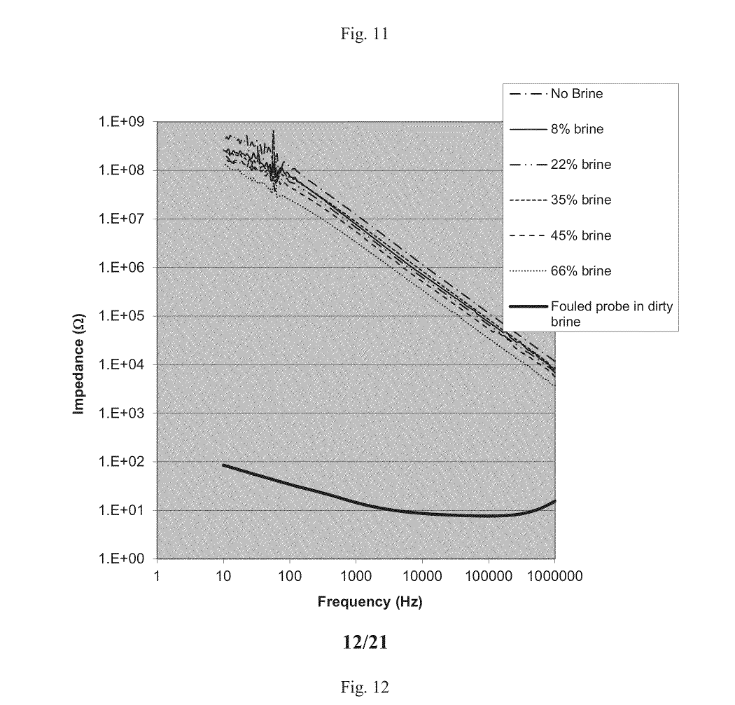

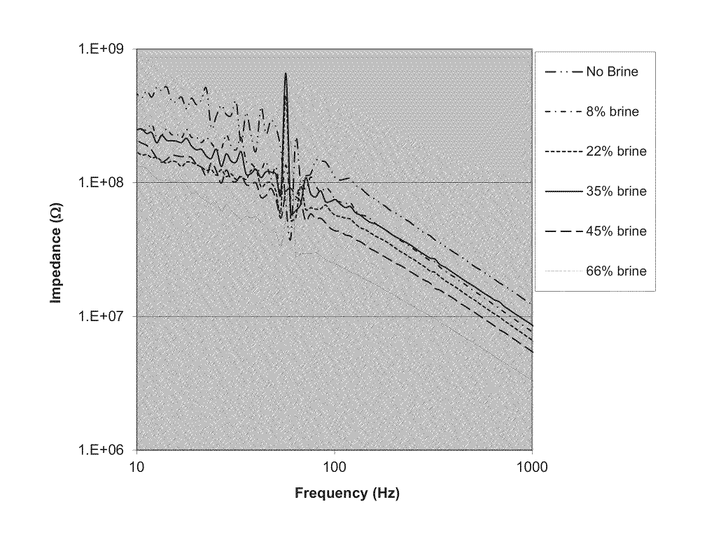

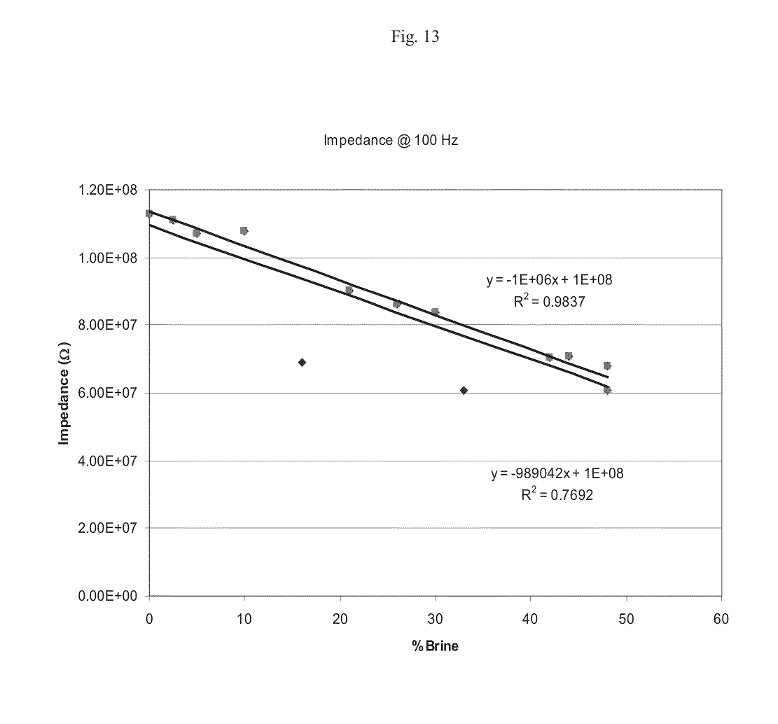

The sensor of this disclosure is also capable of detecting emulsified water in crude oil. Emulsion samples were prepared by blending volumes of brine and Marimba crude in a Waring blender. FIG. 11 shows the impedance spectrum of emulsions with varying amounts of brine as the total liquid volume. The amount of brine noted in the legend in FIG. 11 was added successively, i.e., there was one sample and the brine was added and blended together. The blue line represents the spectrum of the brine measured with fouled electrodes. The impedance of the emulsion is similar to the impedance of Marimba crude. FIG. 12 shows an expanded view of the portion of the impedance spectrum from FIG. 11 near 100 Hz. FIG. 13 plots the average impedance between 95-107 Hz against % brine in the emulsion. The impedance generally decreases as additional brine is added to the liquid demonstrating the ability to measure concentration of emulsified water. The pink squares are the series that have an r² trend line of 0.98. The lower trend line is for all points including those in blue.

### Example 6

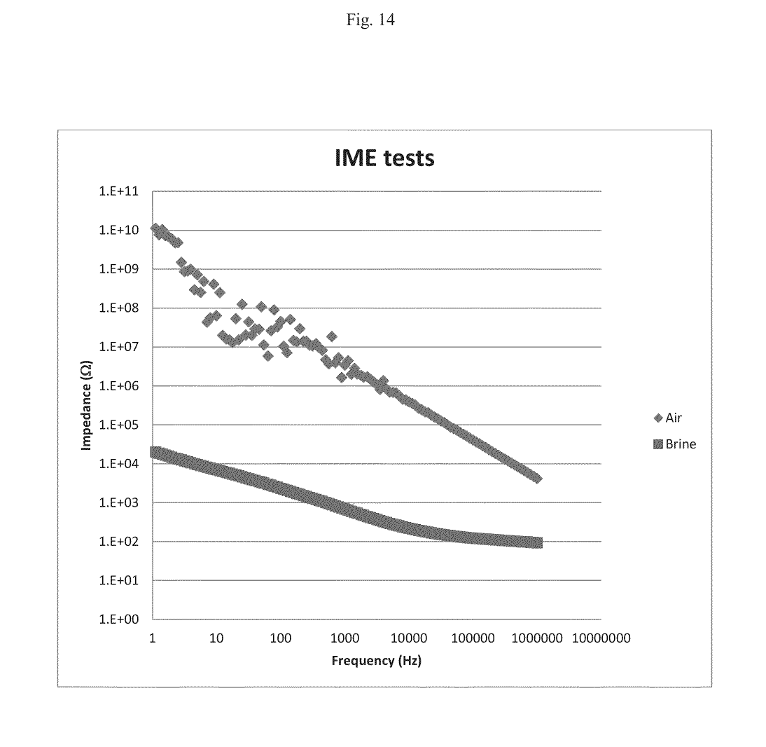

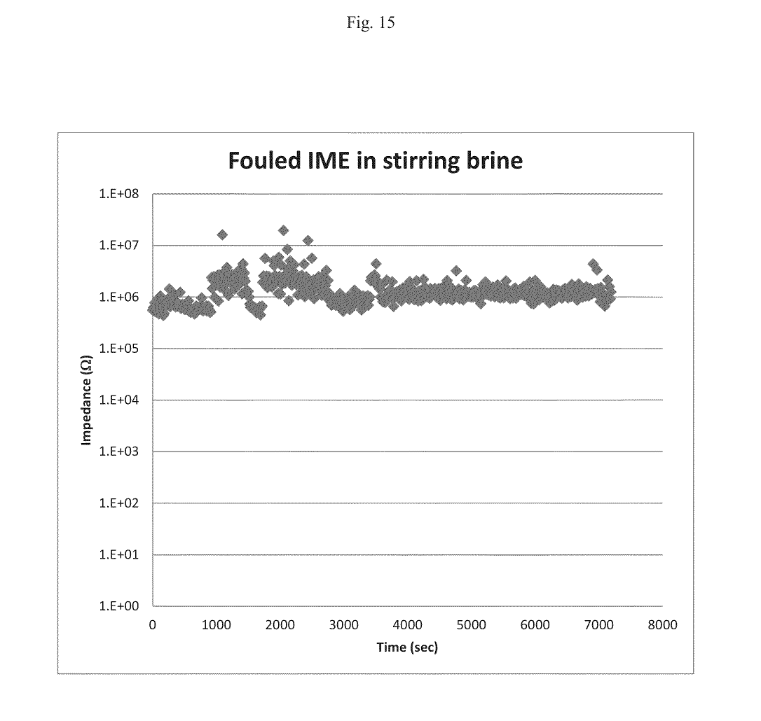

An interdigitated microelectrode (ABTECH Scientific, Inc. IME 1050.5-M-Au-U) geometry was also tested. This electrode had two comb-shaped monolithic electrodes made of gold that were interdigitated with one another. The electrodes were supported by a glass substrate. The gold electrodes were separated by 10 μm. FIG. 14 shows that the impedance of crude oil is differentiable from brine. The performance was significantly degraded by fouling. FIG. 15 shows a plot of impedance versus time with the potentiostat set at 1 kHz and the crude-fouled electrode sitting in a stirred-brine solution. The measured impedance does not indicate that the electrode is in free water.

### Example 7

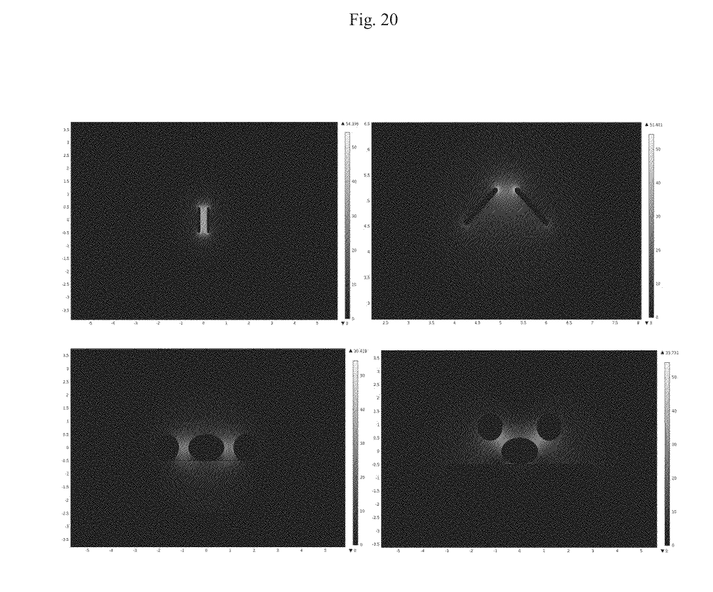

Although several electrode geometries can be used for the apparatus of the present disclosure, the flat parallel plate electrodes were found to be the preferred geometry. Finite element modeling was completed on several electrode geometries with minimum electrode separations (4 mm) and common material properties (copper electrodes and oil). FIG. 20 displays the electric field strength in two dimensions in a common color scale with the intensity of the color scale matched in each image. The electric field is not only greater in the volume between the parallel plate electrodes (top-left of FIG. 20), it is also more uniform over the volume of material between the electrodes. The other geometries modeled were diagonal plates (top-right of FIG. 20), planar torroids (bottom-left of FIG. 20), and non-planar torroids (bottom-right of FIG. 20). The substrate for the planar torroids was glass and the substrate for the non-planar torroids was nylon. The planar torroidal pattern was similar to the interdigitated microelectrode (IME). Glass was the substrate for the IME experiments. The electric field between the electrodes was greatest at the minimum distance between electrodes in each geometry. This means that the fluid between the electrodes at their minimum separation will contribute significantly more to the recorded signal.

### Example 8

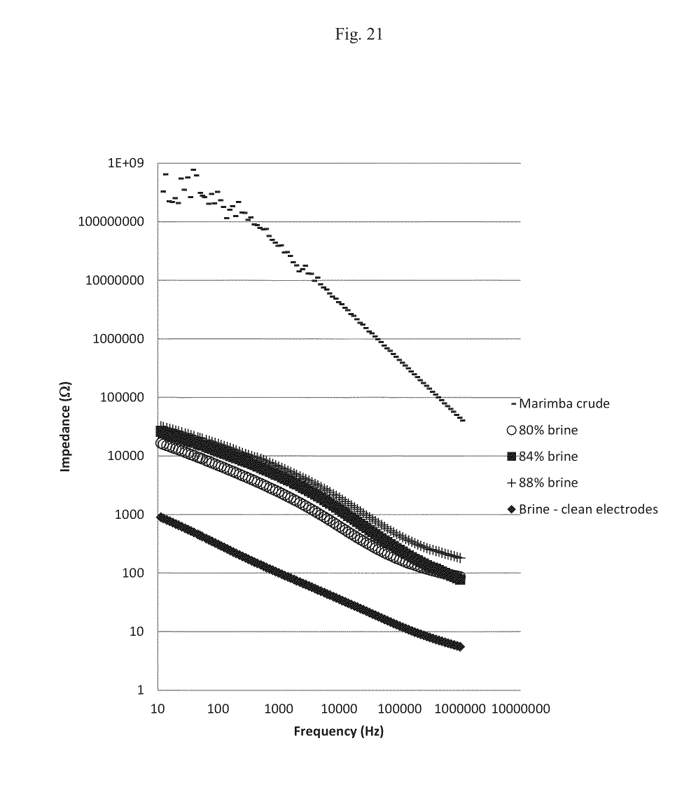

The sensor of this disclosure is also capable of detecting emulsified water where water is the continuous phase and oil is dispersed into it. FIG. 21 shows a plot of impedance and frequency of a condensate-brine volume. The sensor used to obtain this data was a pair of flat, parallel copper plates. The surface are of each was 1 cm² and the faces were separated by 4 mm. The volume was changed by four volume percent. The response of the sensor in oil-in-water emulsions was different than the response of water-in-oil emulsions. FIG. 21 shows a plot of Marimba crude oil-in-brine emulsions with the amount of brine noted. Since the continuous phase of the emulsions was water, the impedance recorded was considerably lower that the impedance of the oil-continuous emulsion. FIG. 21 demonstrates the ability of the sensor to differentiate between brine-continuous emulsions and both crude oil and crude oil-continuous emulsions.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. An apparatus for detecting the presence of water in a current of liquid hydrocarbons, the apparatus comprising:
at least one pair of electrodes for detecting the presence of water in a sample zone in the current of liquid hydrocarbons located therebetween;
alternating current (AC) generating circuitry for generating an alternating current between the electrodes;
measuring circuitry for measuring the electrical impedance of the current of liquid hydrocarbons between the electrodes; and
a processor for collecting data from the measuring circuitry, processing the data and outputting the data for use in detecting the presence of water in the current of liquid hydrocarbons.

2. The apparatus of claim 1 which is positioned in a pipeline and moves through the pipeline.

3. The apparatus of claim I wherein the at least one pair of electrodes has a gap between the electrodes sufficient to allow water and liquid hydrocarbon in between, and allow the electrodes to remain within electrical contact.

4. The apparatus of claim 1 wherein the at least one pair of electrodes has a gap between the electrodes from 1 and 15 millimeters, and an area of overlap between each electrode pair from 0.1 and 100 square centimeters.

5. The apparatus of claim 1 wherein the alternating current is generated at a predetermined amplitude.

6. The apparatus of claim 1 having a configuration of electrodes in which either a sinusoidal current of constant RMS amplitude is applied across the electrodes or a sinusoidal voltage of constant RMS amplitude is applied across the electrodes.

7. A method for detecting the presence of water in a current of liquid hydrocarbons comprising:
providing an apparatus comprising:
at least one pair of electrodes for detecting the presence of water in a sample zone in the current of liquid hydrocarbons located therebetween;
alternating current (AC) generating circuitry for generating an alternating current between the electrodes;
measuring circuitry for measuring the electrical impedance of the current of liquid hydrocarbons between the electrodes; and
a processor for collecting data from the measuring circuitry, processing the data, and outputting the data; and
using the outputted data from said apparatus for detecting the presence of water in the current of liquid hydrocarbons.

8. The method of claim 7 wherein the apparatus is positioned in a pipeline and moves through the pipeline.

9. The method of claim 7 wherein the at least one pair of electrodes has a gap between the electrodes sufficient to allow water and liquid hydrocarbon in between, and allow the electrodes to remain within electrical contact.

10. The method of claim 7 wherein the at least one pair of electrodes has a gap between the electrodes from 1 and 15 millimeters, and an area of overlap between each electrode pair from 0.1 and 100 square centimeters.

11. The method of claim 7 wherein the alternating current is generated at a predetermined amplitude.

12. The method of claim 7 wherein the apparatus has a configuration of electrodes in which either a sinusoidal current of constant RMS amplitude is applied across the electrodes or a sinusoidal voltage of constant RMS amplitude is applied across the electrodes.

13. A method for detecting the presence of water in a current of liquid hydrocarbons comprising:
applying alternating current (AC) to a portion of the current of liquid hydrocarbons; and
measuring the electrical impedance spectrum across the portion of the current of liquid hydrocarbons;
whereby the presence of water can be determined from the measured electrical impedance spectrum.

14. A method for quantifying the amount of water present in a current of liquid hydrocarbons comprising:
applying alternating current (AC) to a portion of the current of liquid hydrocarbons; and
measuring the electrical impedance spectrum across the portion of the current of liquid hydrocarbons;
whereby the amount of water can be determined from the measured electrical impedance spectrum.

15. An apparatus for quantifying the amount of free water present in a current of liquid hydrocarbons, the apparatus comprising:
at least two pairs of electrodes for detecting the presence of water in sample zones in the current of liquid hydrocarbons located therebetween;
alternating current (AC) generating circuitry for generating an alternating current between each pair of electrodes;
measuring circuitry for measuring the electrical impedance of the current of liquid hydrocarbons between each pair of electrodes; and
a processor for collecting data from the measuring circuitry, determining which of the electrodes is in contact with water, processing the data and outputting the data for use in determining the height of the water level in the current of liquid hydrocarbons.

16. The apparatus of claim 15 which is positioned in a pipeline and moves through the pipeline.

17. The apparatus of claim 15 wherein the at least one pair of electrodes has a gap between the electrodes sufficient to allow water and liquid hydrocarbon in between, and allow the electrodes to remain within electrical contact.

18. The apparatus of claim 15 wherein the at least two pairs of electrodes have opposing faces that are flat and parallel.

19. The apparatus of claim 15 wherein the at least one pair of electrodes has a gap between the electrodes from 1 and 15 millimeters, and an area of overlap between each electrode pair from 0.1 and 100 square centimeters.

20. The apparatus of claim 16 which is fitted with a computer and a positioning device capable of determining position of said apparatus inside the pipeline.

21. A method for quantifying the amount of free water present in a current of liquid hydrocarbons comprising:
providing an apparatus comprising:
at least two pairs of electrodes for detecting the presence of water in sample zones in the current of liquid hydrocarbons located therebetween;
alternating current (AC) generating circuitry for generating an alternating current between each pair of electrodes;
measuring circuitry for measuring the electrical impedance of the current of liquid hydrocarbons between each pair of electrodes; and
a processor for collecting data from the measuring circuitry, determining which of the electrodes is in contact with water, processing the data and outputting the data for use in determining the height of the water level in the current of liquid hydrocarbons; and
using the outputted data from said apparatus for quantifying the amount of free water present in a current of liquid hydrocarbons.
